(19) United States
(12) Patent Application Publication
(10) Pub. No.: US 2023/0029605 A1
(43) Pub. Date: Feb. 2, 2023

(54) LENS DRIVING DEVICE, CAMERA MODULE, AND CAMERA MOUNT DEVICE

(71) Applicants: Tomohiko OSAKA, Tokyo (JP); Shun SUZUKI, Tokyo (JP)

(72) Inventors: Tomohiko OSAKA, Tokyo (JP); Shun SUZUKI, Tokyo (JP)

(73) Assignee: Mitsumi Electric Co., Ltd., Tokyo (JP)

(21) Appl. No.: 17/791,560

(22) PCT Filed: Jan. 14, 2021
(86) PCT No.: PCT/JP2021/000950

§ 371 Date: Jul. 8, 2022

Related U.S. Application Data
(60) Provisional application No. 62/960,727, filed on Jan. 14, 2020.

(51) Int. Cl. G02B 7/08; G03B 13/36

(52) U.S. Cl. CPC G02B 7/08; G03B 13/36

(57) ABSTRACT

This lens driving device comprises: a first movable part and a second movable part; a first driving part and a second driving part that are respectively disposed on the first movable part and on the second movable part, on one end side thereof; and a guide part. A first ultrasound motor and a second ultrasound motor are arranged on the one end side. The guide part includes a plurality of guide shafts that support both a first frame and a second frame in a movable manner.

### TECHNICAL FIELD

The present invention relates to a lens driving device, a camera module, and a camera-mounted device.

### BACKGROUND ART

Conventionally, a camera module mounted on a thin camera-mounted device such as a smartphone is known. Such a camera module is known to include a lens driving device having a zoom function for enlarging or downsizing a subject image.

For example, PTL 1 discloses a configuration including a fixed lens on which light from a subject is incident, two movable lenses on which the light deflected by the fixed lens is incident, and a lens driving part for moving the two movable lenses in the direction of the optical axis.

The lens driving part has a feed screw mechanism based on a motor corresponding to each of the two movable lenses. The motors are disposed on both end sides of a housing of a camera module in the direction of the optical axis in a region adjacent to the fixed lens and the movable lenses. A drive shaft of each of the motors is provided with an engaging nut that is engaged with a frame of the movable lens and is movable on the drive shaft by the rotation of the drive shaft. The movable lens moves when the engaging nut moves on the drive shaft by the rotational drive of the motor.

### CITATION LIST

### Patent Literature

### PTL 1

Japanese Patent Application Laid-Open No. 2018-36416

### SUMMARY OF INVENTION

### Technical Problem

However, in a compact camera-mounted device, it is necessary to reduce the size of the lens driving device correspondingly to the camera-mounted device. Thus, the rigidity reduction of the device due to the miniaturization of the lens driving device has been a problem. Further, in the case of such a configuration as the configuration described in PTL 1 in which two relatively large stepping motors are disposed, an excessively large outer shape of the lens driving device may be caused if the amount of movement of the movable lens is taken into consideration.

An object of the present invention is to provide a lens driving device, a camera module, and a camera-mounted device capable of achieving miniaturization while ensuring rigidity of the device.

### Solution to Problem

A lens driving device according to the present invention includes:
a first movable part and a second movable part that are disposed in a direction of an optical axis and are capable of holding a first movable lens and a second movable lens, respectively;
a first driving part and a second driving part, both of which are disposed on one end side of opposite ends of the first movable part and the second movable part with respect to the optical axis, the first driving part and the second driving part being configured to drive the first movable part and the second movable part in the direction of the optical axis, respectively; and
a guide part that is disposed on the one end side and is configured to guide movement of each of the first movable part and the second movable part in the direction of the optical axis, in which
the first driving part includes a first ultrasonic motor and a first frame connected to the first movable part,
the second driving part includes a second ultrasonic motor and a second frame connected to the second movable part,
the first ultrasonic motor and the second ultrasonic motor are disposed side by side in the direction of the optical axis on the one end side, and are configured to respectively drive the first movable part and the second movable part independently in the direction of the optical axis, and
the guide part includes a plurality of guide shafts that extend in the direction of the optical axis and are disposed to be spaced apart from each other, the plurality of guide shafts being configured to cooperate to support both of the first frame and the second frame such that the first frame and the second frame are movable in the direction of the optical axis.

A camera module according to the present invention includes:
the aforementioned lens driving device;
a lens part including the first movable lens and the second movable lens held by the first movable part and the second movable part; and
an image capturing part configured to capture a subject image imaged by the lens part, in which
the first movable lens and the second movable lens are driven in the direction of the optical axis.

A camera-mounted device according to the present invention is
a camera-mounted device that is an information apparatus or a transporting apparatus, the camera-mounted device including:
the above-described camera module; and
an image capturing control part that processes image information obtained by the camera module.

### ADVANTAGEOUS EFFECTS OF INVENTION

According to the present invention, miniaturization can be achieved while securing the rigidity of the device.

### BRIEF DESCRIPTION OF DRAWINGS

FIG. 1 schematically illustrates a camera module according to an embodiment of the present invention;

FIG. 2 schematically illustrates a configuration of the camera module as seen in a side view according to the present embodiment;

FIG. 3 is a perspective view illustrating a housing portion of the camera module;

FIG. 4 is a perspective view of a bottom wall portion side of the housing portion of the camera module;

FIG. 5 is an exploded perspective view of a housing and a lens part;

FIG. 6 is an exploded perspective view of a side wall portion and the bottom wall portion of the housing;

FIG. 7 illustrates the housing as seen from the + side in the Z direction;

FIG. 8 illustrates the inside of the housing as seen from the − side in the X direction;

FIG. 9 is a diagram illustrating a guided portion;

FIG. 10 is a diagram illustrating a connecting portion between the lens part and a frame;

FIG. 11 is an exploded perspective view of the guided portion and an interposition part;

FIG. 12A is a diagram for explaining the positional relationship between a magnet and a position detecting part;

FIG. 12B is a diagram for explaining the positional relationship between the magnet and the position detecting part;

FIG. 12C is a diagram for explaining the positional relationship between the magnet and the position detecting part;

FIG. 13A is a diagram for explaining adjustment of the positional relationship between the interposition part and a guide shaft;

FIG. 13B is a diagram for explaining adjustment of the positional relationship between the interposition part and the guide shaft;

FIG. 14 is a diagram illustrating a second interposition member;

FIG. 15 a diagram illustrating the arrangement relationship between the interposition part and an ultrasonic motor;

FIG. 16 is a perspective view of the ultrasonic motor;

FIG. 17 is an exploded perspective view of the ultrasonic motor;

FIG. 18 is an enlarged view of a contact portion between a resonant portion and the interposition part;

FIG. 19 is a diagram for explaining the configuration of a guide part;

FIG. 20 is a diagram for explaining the configuration of the guide part;

FIG. 21A a diagram illustrating a smartphone in which the camera module is mounted;

FIG. 21B is a diagram illustrating the smartphone in which the camera module is mounted;

FIG. 22A is a diagram illustrating an automobile in which the camera module is mounted; and

FIG. 22B is a diagram illustrating the automobile in which the camera module is mounted.

### DESCRIPTION OF EMBODIMENTS

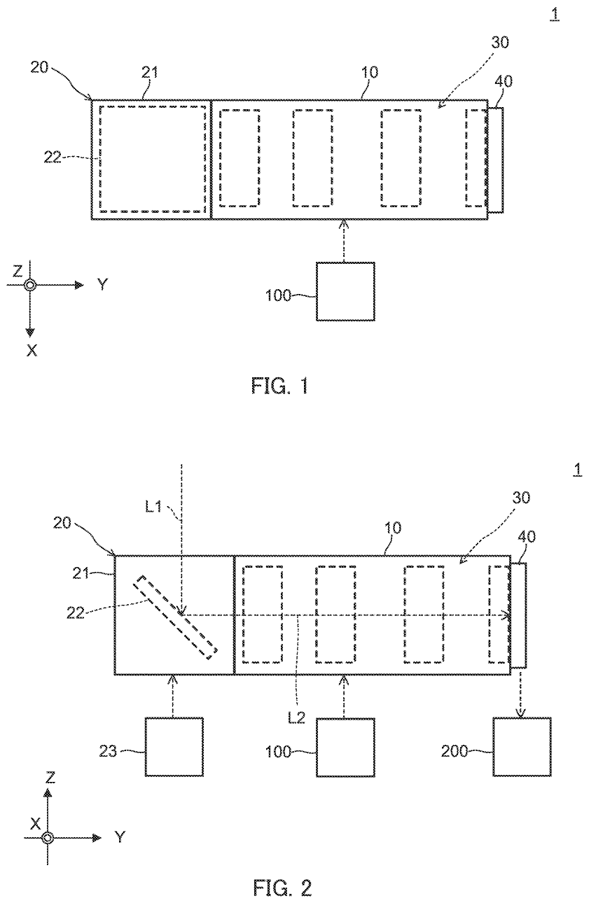

Hereinafter, embodiments of the present invention will be described in detail with reference to the drawings. FIG. 1 is a diagram schematically illustrating camera module 1 according to an embodiment of the present invention. FIG. 2 is a diagram schematically illustrating a configuration of camera module 1 according to the present embodiment as viewed from the side.

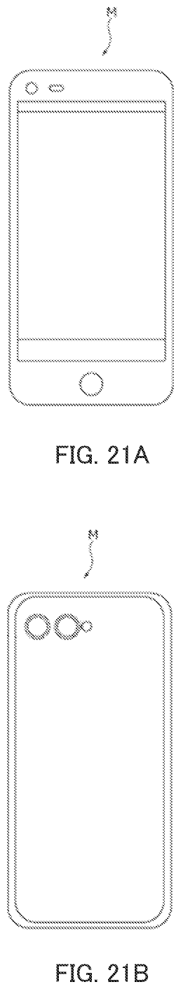

Camera module 1 is mounted in thin camera-mounted devices such as, for example, smartphone M (see FIG. 21A and FIG. 21B), a mobile phone, a digital camera, a notebook personal computer, a tablet terminal, a portable game machine, in-vehicle camera, and the like.

In explaining the structure of camera module 1 of the present embodiment, an orthogonal coordinate system (X, Y, Z) is used. The same orthogonal coordinate system (X, Y, Z) is also used for illustration of below-mentioned figures. Camera module 1 is mounted such that the horizontal direction is the X-direction, the vertical direction is the Y-direction, and the front-rear direction is the Z-direction, for example, during actually capturing an image with a camera-mounted device. Light from a subject is incident from the − side (minus side) in the Z direction, and is deflected and guided to the + side (plus side) in the Y direction. By reducing the thickness of camera module 1 in the Z direction, it is possible to reduce the thickness of the camera-mounted device.

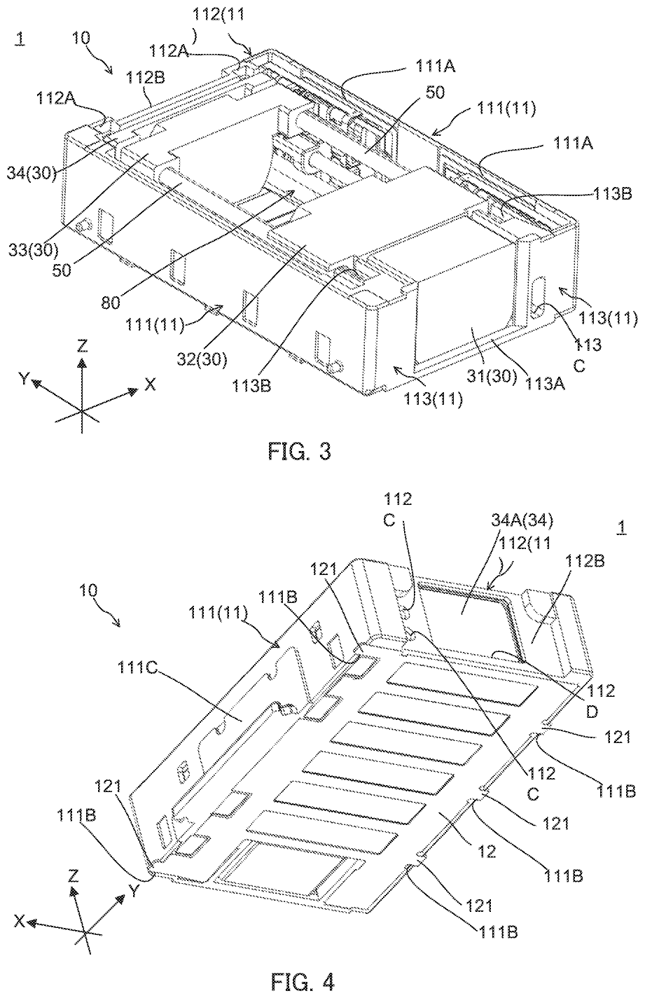

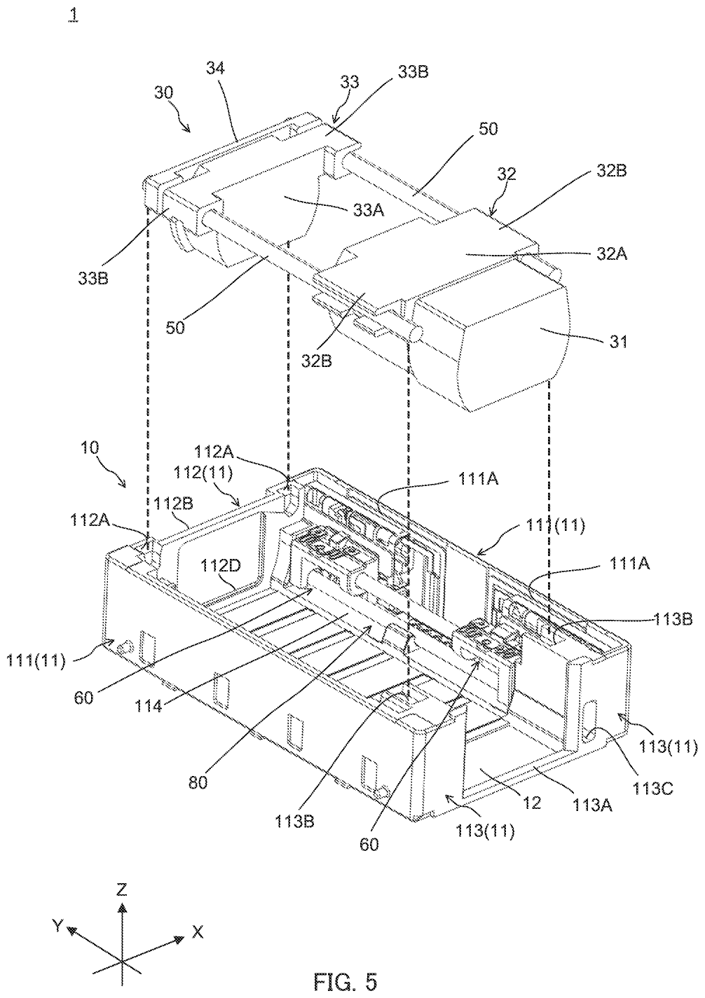

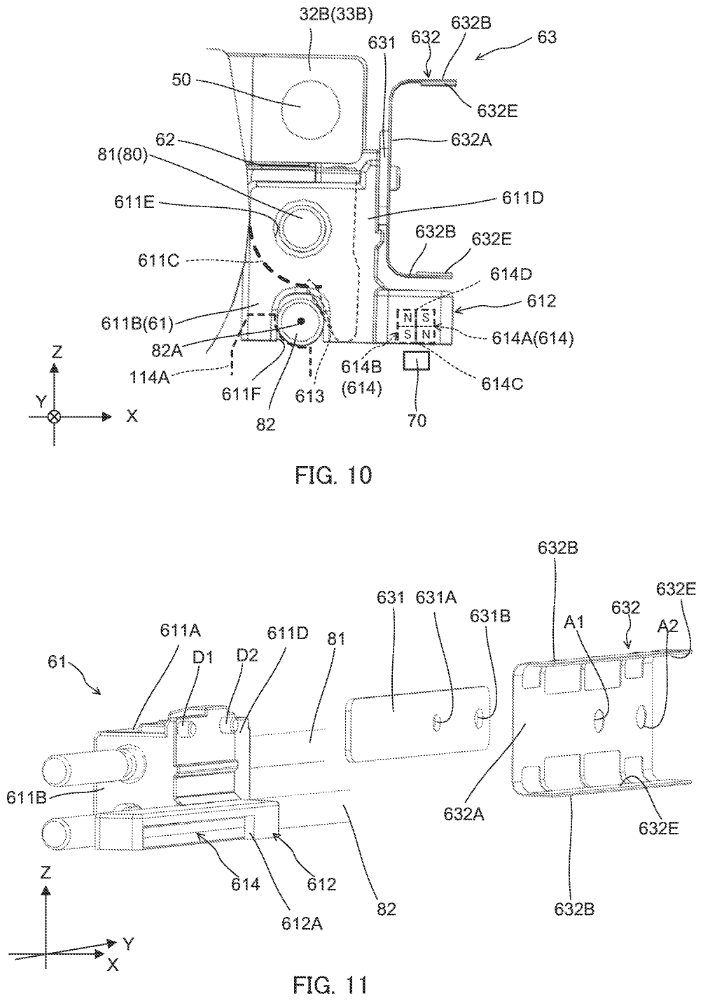

As illustrated in FIG. 1, camera module 1 includes housing 10, reflection driving part 20, lens part 30, image capturing part 40, support shafts 50 (see FIG. 3), lens driving parts 60 (see FIG. 5), position detecting part 70 (see FIG. 10), guide part 80 (see FIG. 3), and drive control part 100.

Drive control part 100 includes a Central Processing Unit (CPU), Read Only Memory (ROM), Random Access Memory (RAM), or the like. The CPU reads a program suited to processing contents out of the ROM, develops the program in the RAM, and integrally controls an operation of each block of lens driving parts 60 in cooperation with the developed program. Thus, drive control part 100 drives, in the Y direction (the direction of the optical axis), second lens unit 32 and third lens unit 33 to be described later of lens part 30 housed in housing 10. As a result, camera module 1 performs stepless optical zoom and autofocus. Housing 10, support shafts 50, lens driving parts 60, position detecting part 70, guide part 80 and drive control part 100 correspond to the “lens driving device” of the present invention.

Further, as illustrated in FIG. 2, in camera module 1, incident light L1 is incident on housing 10 via reflection driving part 20. Reflection driving part 20 includes a reflecting housing 21, mirror 22 and reflection drive control part 23. In the example illustrated in FIGS. 1 and 2, reflecting housing 21 is disposed adjacent to an end portion of housing 10 on the − side in the Y direction. Mirror 22 is disposed in reflecting housing 21, and reflects incident light L1 toward housing 10 as reflected light L2. Reflection drive control part 23 includes a CPU, a ROM, a RAM, and the like, and controls the orientation of mirror 22.

Mirror 22 according to the present embodiment has two rotation axes (not illustrated) extending in the X direction and the Z direction. In reflection driving part 20, mirror 22 is rotated about the rotation axes under the control of reflection drive control part 23. Thus, camera module 1 has a shake correction function (Optical Image Stabilization (OIS) function) for optically correcting a shake (vibration) that occurs during capturing an image, so as to reduce image irregularities.

Reflected light L2 incident on housing 10 is outputted to image capturing part 40 via lens part 30 accommodated in housing 10.

Image capturing part 40 is disposed on the outer surface of housing 10 on the + side in the Y-direction (placement portion 112B of second wall 112 to be described later), and is configured to allow reflected light L2 to be incident thereon through lens part 30. Image capturing part 40 includes an image capturing device, a board, and the like (not illustrated).

The image capturing device is composed of, for example, a Charge-Coupled Device (CCD) image sensor, a Complementary Metal Oxide Semiconductor (CMOS) image sensor, or the like. The image capturing device is mounted on the board and electrically connected to the interconnections on the board via bonding wires. The image capturing device captures a subject image imaged by lens part 30 and outputs an electrical signal corresponding to the subject image.

Further, a printed wiring board (not illustrated) is electrically connected to the board of image capturing part 40. The power supply to the image capturing device and the output of the electrical signal of the subject image imaged by the image capturing device are performed via the printed wiring board. The electrical signal is outputted to image capturing control part 200 disposed in the camera-mounted device. Image capturing control part 200 includes a CPU, a ROM, a RAM, and the like, and processes image information obtained by camera module 1. Image capturing control part 200 may be mounted on the camera-mounted device, or may also be built in camera module 1.

As illustrated in FIG. 3, housing 10 houses lens part 30, support shafts 50, lens driving parts 60 (see also FIG. 5), and guide part 80, and for example, has a rectangular parallelepiped shape as a whole. Housing 10 has side wall portion 11, and bottom wall portion 12.

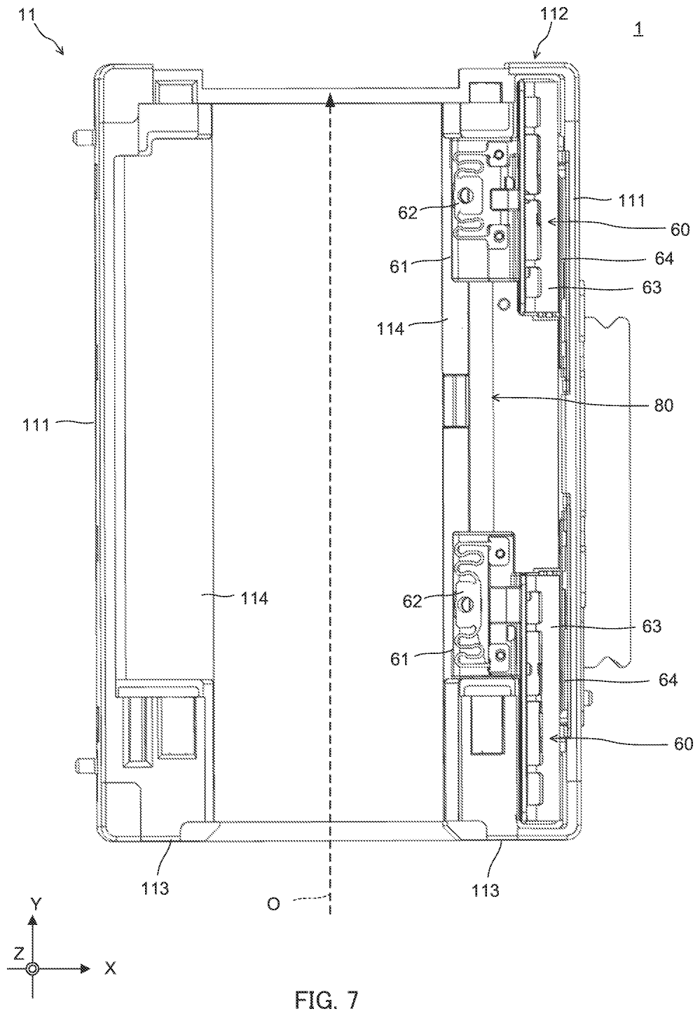

Side wall portion 11 is a wall portion made of, for example, resin and having a portion opening on the − side in the Y direction, and has first walls 111, second wall 112, third wall 113, and fourth wall 114 (see also FIG. 7 and the like).

A pair of first walls 111 are configured to extend in the Y direction, and are disposed on both sides in the X direction. Of the pair of first walls 111, the inner surface of first wall 111 of housing 10 on the + side in the X-direction, placement portions 111A on which an ultrasonic motor to be described later is disposed are provided. On one of first walls 111 situated on the + side in the X direction, placement portions 111A are disposed on both sides of the central portion in the Y direction.

Further, as illustrated in FIG. 4, terminal portion 111C is disposed on first wall 111 on the + side in the X direction. Terminal portion 111C includes a terminal disposed across the inside and outside of housing 10 via a gap formed between first wall 111 and bottom wall portion 12, for example (not illustrated). A portion of the terminal disposed outside housing 10 is connected to predetermined interconnections of the camera-mounted device.

Further, engaged portions 111B with which positioning portions 121 of bottom wall portion 12 are engaged are formed in the bottom surface of first wall 111 (the surface on the − side in the Z direction).

As illustrated in FIGS. 3 and 4, second wall 112 is configured to extend in the X direction, and is disposed to connect together the end portions of the pair of first walls 111 on the + side in the Y direction. Further, in portions of the top surface of second wall 112 (the surface on the + side in the Z direction), supporting parts 112A for supporting support shafts 50 are provided on both sides in the X direction, respectively. Placement portion 112B on which image capturing part 40 is disposed is disposed on the outer surface of second wall 112.

Further, guide supporting portions 112C and opening portion 112D are formed in placement portion 112B of second wall 112. In the present embodiment, guide supporting portions 112C are holes for supporting guide shafts 81 and 82 to be described later, and are formed on the − side of opening portion 112D in placement portion 112B in the X-direction. Two guide supporting portions 112C are formed side by side in the Z-direction. Opening portion 112D is an opening in which fourth lens unit 34 of lens part 30 is fitted, and is formed in placement portion 112B at the central portion in the X-direction.

As illustrated in FIGS. 3 and 5, third walls 113 are disposed respectively on the end portions of the pair of first walls 111 on the − side in the Y direction. The pair of third walls 113 are disposed to surround a space formed by first wall 111 and second wall 112. Between the pair of third walls 113, a gap large enough for first lens unit 31 of lens part 30 to enter there, and bridging portion 113A for bridging the ends of respective third walls 113 on the − side in the Z-direction are disposed.

Further, supporting portions 113B for supporting support shafts 50 are formed in the top surfaces of the pair of third walls 113 (the surfaces on the + side in the Z direction). Guide supporting portion 113C for supporting guide shafts 81 and 82 to be described later is formed in the pair of third walls 113 near the central portion in the Z-direction.

Guide supporting portion 113C is a long hole configured to have a length in the Z direction corresponding to the placement range of two guide supporting portions 112C in second wall 112 described above. Guide supporting portion 113C is capable of supporting guide shafts 81 and 82 supported respectively by two guide supporting portions 112C in second wall 112.

As illustrated in FIG. 5, fourth walls 114 form bottom walls of the space formed by first walls 111, third walls 113 corresponding to first walls 111, and second wall 112, and are disposed in regions corresponding to third walls 113 in the X direction (see also FIG. 7). Therefore, a gap is formed between fourth walls 114 on both sides in the X direction.

As illustrated in FIGS. 4 to 6, bottom wall portion 12 is, for example, a substantially rectangular metal plate forming the bottom wall of housing 10, and is disposed to bridge fourth walls 114 and the pair of first walls 111 on both sides in the X direction. Bottom wall portion 12 is integrated by insert molding with the bottom portions of side wall portions 11 including the bottom portions of the pair of first walls 111. Further, in order that there is not any portion of bottom wall portion 12 at a portion corresponding to first lens unit 31, an end portion of bottom wall portion 12 on the − side in the Y direction is cut out.

Positioning portions 121 are formed on the both lateral ends of bottom wall portion 12 in the X direction. Positioning portions 121 are formed to protrude from the both lateral ends of bottom wall portion 12, and are to be engaged with engaged portions 111B of first wall 111 described above. Thus, it is possible to position bottom wall portion 12 in the Y direction.

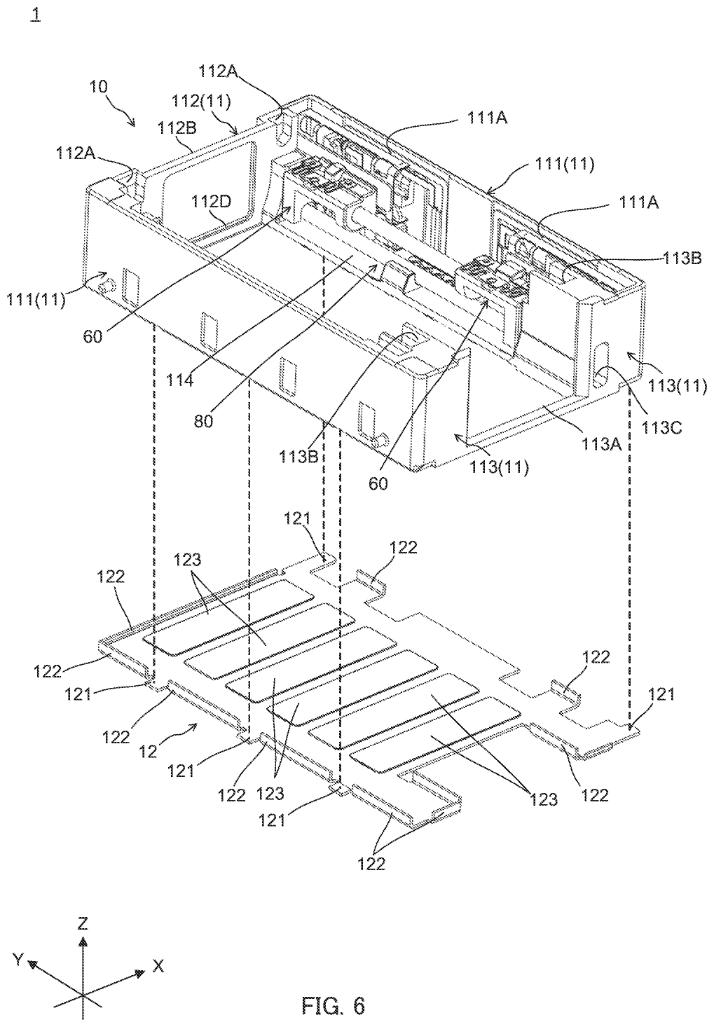

Further, as illustrated in FIG. 6, bent portions 122 are disposed on the lateral ends of bottom wall portion 12 in the X direction and Y direction. Bent portions 122 are formed by bending the lateral ends on the + side in the Z direction.

Further, grooves (not illustrated) in which bent portions 122 are fitted are formed in portions of housing 10 corresponding to bent portions 122. Bent portions 122 are fitted in the grooves, and accordingly, bottom wall portion 12 is fixed to housing 10.

Further, a plurality of half punches 123 arranged in the Y direction are formed in the surface of bottom wall portion 12. Half punches 123 are formed in bottom wall portion 12 over the X direction. In the present embodiment, a total of six half punches 123 are formed.

Such formation of half punches 123 can improve the strength of the bottom wall portion of housing 10.

As illustrated in FIGS. 3 and 5, lens part 30 is disposed in a region that is interposed between the pair of first walls 111 and that includes a region where reflected light L2 from reflection driving part 20 (see FIG. 2) passes. Lens part 30 includes first lens unit 31, second lens unit 32, third lens unit 33, and fourth lens unit 34 that are arranged side by side in the Y direction.

First lens unit 31 is disposed on the most upstream side in the incidence direction of reflected light L2 (direction toward the + side in the Y direction), and is fixed between the pair of third walls 113 in housing 10.

The side surfaces of first lens unit 31 are configured to be curved so as to be convex at central portions in the Z direction, for example. The side surfaces of third wall 113 on the first lens unit 31 side are shaped, for example, to conform the side surfaces of first lens unit 31, and are configured such that the curved portions of first lens unit 31 are fitted thereto. Thus, first lens unit 31 is fixed between the pair of third walls 113.

Second lens unit 32 is disposed on the downstream side of first lens unit 31 in the incidence direction, and includes main body portion 32A and supported portions 32B. Third lens unit 33 is disposed on the downstream side of second lens unit 32 in the incidence direction, and includes main body portion 33A and supported portions 33B. Second lens unit 32 corresponds to the “first movable part” of the present invention, and third lens unit 33 corresponds to the “second movable part” of the present invention.

Main body portions 32A and 33A hold a lens through which the light having passed through first lens unit 31 passes. Supported portions 32B and 33B are portions movably supported by support shafts 50 and are disposed on both sides of main body portions 32A and 33A in the X-direction.

The lens included in main body portion 32A of second lens unit 32 corresponds to the “first movable lens” of the present invention. The lens included in main body portion 33A of third lens unit 33 corresponds to the “second movable lens” of the present invention.

Fourth lens unit 34 is disposed on the most downstream side in the incidence direction, and is configured to include a lens. Fourth lens unit 34 is supported by support shafts 50 at a position adjacent to second wall 112 of housing 10. As illustrated in FIG. 4, in the present embodiment, protruding portion 34A is formed on the surface of fourth lens unit 34 on the + side in the Y-direction.

The lenses in first to fourth lens units 31 to 34 may be assembled to housing 10 when the lens driving device is manufactured, or may be assembled to housing 10 when camera module 1 is manufactured from the lens driving device.

Protruding portion 34A has a size making it possible to be fitted into opening portion 112D in second wall 112. By this protruding portion 34A fitted into opening portion 112D, fourth lens unit 34 is fixed to housing 10.

As illustrated in FIGS. 3 and 5, support shafts 50 are formed of, for example, stainless steel or the like. Support shafts 50 extend in the Y direction, and are disposed respectively in regions of the pair of third walls 113. In the present embodiment, support shafts 50 are formed to have equal lengths, and are supported by supporting portions 113B of third walls 113 and supporting portions 112A of second wall 112.

Lens driving parts 60 are disposed to correspond respectively to second lens unit 32 and third lens unit 33, and each of the lens driving parts moves corresponding one of second lens unit 32 and third lens unit 33 independently under the control of drive control part 100 described above. Lens driving parts 60 are disposed in the region of one of fourth walls 114 on the + side in the X direction surrounded by first wall 111, second wall 112, and third wall 113. That is, as illustrated in FIG. 7, lens driving parts 60 are disposed in housing 10 on one end side of opposite ends of second lens unit 32 and third lens unit 33 with respect to optical axis O.

In the present embodiment, two lens driving parts 60 are disposed side by side in the Y direction. One of lens driving parts 60 on the − side in the Y direction drives second lens unit 32 in the Y direction, and the other one of lens driving parts 60 on the + side in the Y direction drives third lens unit 33 in the Y direction. That is, lens driving part 60 on the − side in the Y direction corresponds to the “first driving part” of the present invention, and lens driving part 60 on the + side in the Y direction corresponds to the “second driving part” of the present invention.

Each of lens driving parts 60 has substantially the same configuration in the present embodiment. Thus, in the following description, unless otherwise stated, only lens driving part 60 corresponding to second lens unit 32 will be described, and lens driving part 60 corresponding to third lens unit 33 will not be described. Further, lens driving parts 60 are symmetrically arranged in the Y direction in the present embodiment. Thus, the relationship between the + side and the − side in the Y direction in lens driving part 60 corresponding to third lens unit 33 is reverse with respect to the relationship between the +side and the − side in the Y direction in lens driving part 60 corresponding to second lens unit 32.

Lens driving part 60 includes frame 61, connecting part 62, interposition part 63, and ultrasonic motor 64.

Frame 61 is connected via connecting part 62 to one of supported portions 32B and 33B of second lens unit 32 and third lens unit 33.

Frame 61 on the − side in the Y direction corresponds to the “first frame” of the present invention, and frame 61 on the + side in the Y direction corresponds to the “second frame” of the present invention.

Frame 61 is configured to be movable in the direction of optical axis O by guide part 80 guiding the movement in the direction of optical axis O (Y direction). Movement of frame 61 in the direction of optical axis O causes second lens unit 32 or third lens unit 33 connected to frame 61 via connecting part 62 to also move along support shafts 50.

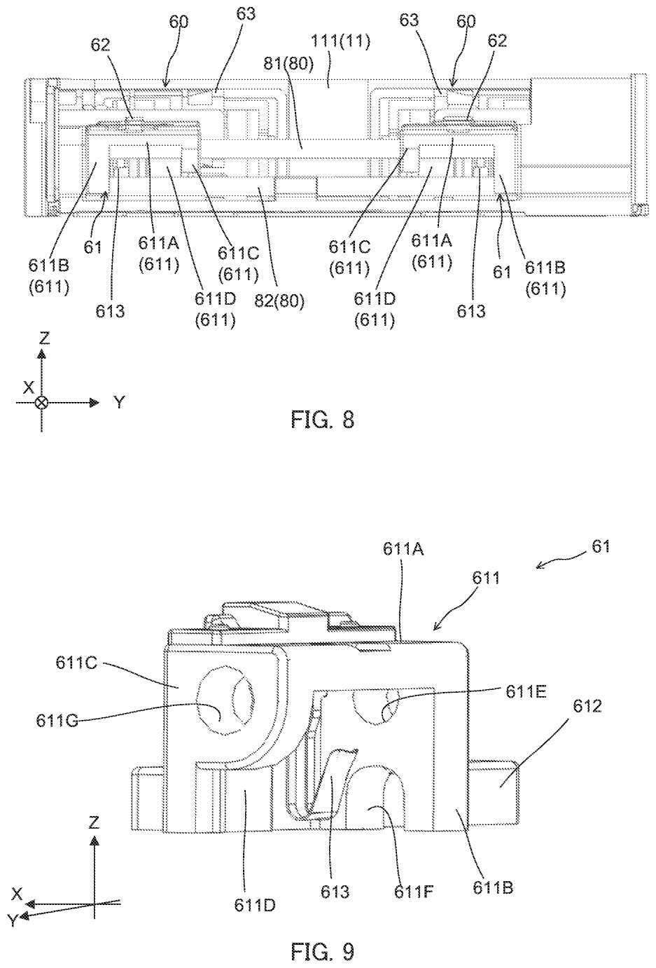

As illustrated in FIGS. 8 and 9, frame 61 includes guided portion 611, and magnet holding portion 612. Guided portion 611 is a portion for guiding the movement of frame 61 by guide part 80 in the Y direction, and is disposed at a position corresponding to guide part 80 in the X direction. Guided portion 611 includes first portion 611A, second portion 611B, third portion 611C, and fourth portion 611D.

First portion 611A is a portion forming the top surface of frame 61 (surface on the + side in the Z direction), and is configured to extend in the direction of the optical axis (Y direction). First portion 611A is provided to cover guide part 80 from the + side in the Z-direction.

Further, connecting part 62 is disposed on the surface on the + side of first portion 611A in the Z-direction. As illustrated in FIG. 10, connecting part 62 is a plate-shaped spring member (elastic member) fixed to the surface of frame 61 on the + side in the Z-direction and to the surface of any of supported portions 32B and 33B of second lens unit 32 and third lens unit 33 on the − side in the Y-direction. By connecting part 62 composed of the spring member, the elastic force of the spring member can absorb the deviation of the positional relationship even when manufacturing tolerances or the like cause the deviation in the positional relationship between frame 61 and supported portions 32B and 33B.

As illustrated in FIGS. 8 to 10, second portion 611B extends to the − side in the Z direction (a predetermined direction) from the end portion of first portion 611A on the − side in the Y direction (one end of first portion 611A), and supports first guide shaft 81 and second guide shaft 82.

Shaft hole 611E extending through in the Y-direction is formed in second portion 611B. Shaft hole 611E is formed at a position corresponding to first guide shaft 81 to be described later, and allows first guide shaft 81 to pass therethrough.

Shaft engaging portion 611F is formed in the end portion of second portion 611B on the − side in the Z-direction. Shaft engaging portion 611F is formed at a position where engagement with below-described second guide shaft 82 is possible, and is engaged with second guide shaft 82 from the + side in the Z direction.

Third portion 611C is a portion that extends to the − side in the Z direction (predetermined direction) from the end portion of first portion 611A on the + side in the Y direction (the other end of first portion 611A), and supports second guide shaft 82. More particularly, third portion 611C extends to a position such that the end portion on the − side in the Z-direction is spaced apart from second guide shaft 82 by a predetermined distance.

Shaft hole 611G extending through in the Y-direction is formed in third portion 611C. Shaft hole 611G is formed at a position corresponding to first guide shaft 81, and allows first guide shaft 81 to pass therethrough.

Fourth portion 611D is a portion extending from the end portion of first portion 611A on the + side in the X-direction. Fourth portion 611D is formed over entire first portion 611A in the Y direction, and is disposed to cover guide part 80 from the + side in the X direction.

Absorbing part 613 is disposed between fourth portion 611D and guide part 80 (second guide shaft 82). Absorbing part 613 is composed of a spring member and is disposed between fourth portion 611D and second guide shaft 82. Absorbing part 613 biases second guide shaft 82 to the − side in the X direction with respect to fourth portion 611D. As a result, absorbing part 613 absorbs a deviation in the positional relationship between frame 61 and guide part 80.

As illustrated in FIGS. 10 and 11, magnet holding portion 612 is a portion for holding magnet part 614 for position detection, and extends to the − side in the X direction from the end portion of fourth portion 611D on the − side in the Z direction. Recess 612A is formed in the end portion of magnet holding portion 612 on the − side in the Z-direction, and magnet part 614 is held in the recess.

Magnet part 614 includes two magnets 614A and 614B disposed side by side in the X-direction.

Further, position detecting part 70 is disposed on a portion of housing 10 facing magnet part 614. Position detecting part 70 is, for example, a Hall element for detecting the position of frame 61 in the Y direction, and detects the position of magnet part 614 based on a predetermined reference position. The predetermined reference position is a common position between two magnets 614A and 614B, for example, and is set to an appropriate position such as an end portion of bottom wall portion 12 on the + side or on the − side in the Y direction.

In magnet part 614, one magnet 614A is disposed such that the N pole faces position detecting part 70, and other magnet 614B is disposed such that the S pole faces position detecting part 70. That is, two magnets 614A and 614B are magnetized in a direction along a direction (Z direction in the present embodiment) in which magnet part 614 faces position detecting part 70, and such that the different poles face position detecting part 70.

Magnets 614A and 614B are disposed in contact with each other. Therefore, the different poles are arranged adjacently at opposing surface 614C of magnet part 614 facing position detecting part 70.

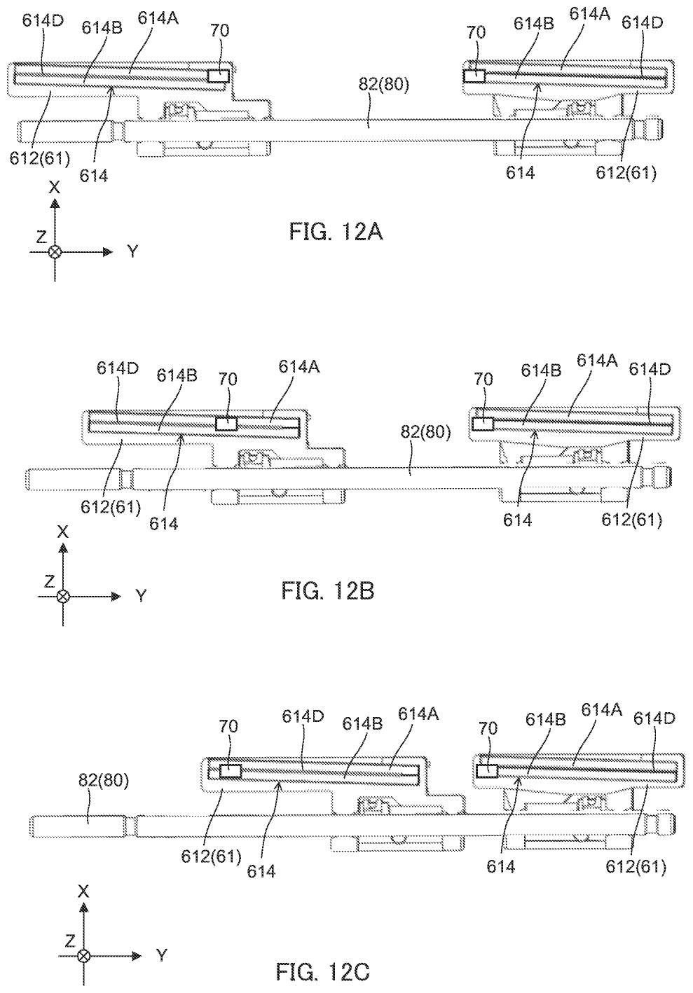

Further, as illustrated in FIGS. 12A, 12B and 12C, magnet parts 614 are disposed to be inclined with respect to the Y direction. That is, border 614D between the different poles in each of magnet parts 614 extends in an inclined manner with respect to the optical axis (Y direction).

With this configuration, the proportion of the N pole and the proportion of the S pole at an opposing portion between position detecting part 70 and magnet part 614 can be made different in accordance with the movement of frame 61 in the Z direction.

For example, as illustrated in FIG. 12A, when the position of frame 61 is at the end on the − side position in the Y direction, position detecting part 70 faces the end portion of magnet part 614 on the + side in the Y direction. Position detecting part 70 faces a portion of the end portion where the proportion of the N pole of magnet 614A is large.

When frame 61 is moved to the + side in the Y direction, magnet part 614 also moves with frame 61. Accordingly, the opposing portion of position detecting part 70 with respect to magnet part 614 changes. Since magnet part 614 is inclined, the proportion of the S pole at the opposing portion with respect to position detecting part 70 gradually increases.

As illustrated in FIG. 12B, when frame 61 moves to a position where position detecting part 70 faces the central portion of frame 61, a portion where the proportion of the S pole (magnet 614B) is substantially equal to the proportion of the N pole (magnet 614A) comes to the opposing portion with respect to position detecting part 70.

Further, as illustrated in FIG. 12C, when frame 61 moves to a position where position detecting part 70 faces the end portion of frame 61 on the + side in the Y direction, a portion where the proportion of the S pole (magnet 614B) is large comes to the opposing portion with respect to position detecting part 70.

Thus, the magnitude of the magnetic force detected by position detecting part 70 can be different between the positions of frame 61. It is thus possible to accurately detect the position of frame 61 in the Y direction by position detecting part 70.

Further, magnet parts 614 in lens driving parts 60 on both sides in the Y direction are disposed such that the same poles face each other when facing each other in the Y direction. That is, magnets 614A face each other at a position where magnet 614A of magnet part 614 on the + side in the Y direction is close to magnet 614A of magnet part 614 on the − side in the Y direction. Further, magnets 614B face each other at a position where magnet 614B of magnet part 614 on the − side in the Y direction is close to magnet 614B of magnet part 614 on the + side in the Y direction.

Thus, for example, even when frames 61 on lens driving parts 60 on both sides in the Y direction come the closest to each other, it is unlikely that magnet parts 614 of both frames 61 attract each other. It is thus possible to suppress the displacement of the positions of frames 61 in the Y direction.

Further, as illustrated in FIGS. 10 and 11, interposition part 63 is disposed above magnet holding portion 612. Interposition part 63 includes first interposition member 631 and second interposition member 632.

First interposition member 631 is formed of, for example, a flat plate-shaped metallic member, and is bonded to the surface of fourth portion 611D of frame 61 on the +side in the X-direction. Two protrusions D1 and D2 are disposed on the surface of fourth portion 611D on the + side in the X-direction.

Two protrusions D1 and D2 project from the surface of fourth portion 611D and are disposed side by side in the Y-direction. In the present embodiment, protrusion D1 is disposed near the center portion of fourth portion 611D in the Y direction, and protrusion D2 is disposed near the end portion of fourth portion 611D on the + side in the Y direction.

First interposition member 631 is disposed parallel to the direction of the optical axis (Y direction), and includes engaging holes 631A and 631B for engagement with two protrusions D1 and D2.

Engaging hole 631A is disposed near the central portion of first interposition member 631 in the Y-direction, and is engaged with protrusion Dl. Engaging hole 631A is formed in a size allowing engagement with protrusion D1, and allowing interposition part 63 (first interposition member 631) to rotate around engaging hole 631A with which protrusion D1 is engaged.

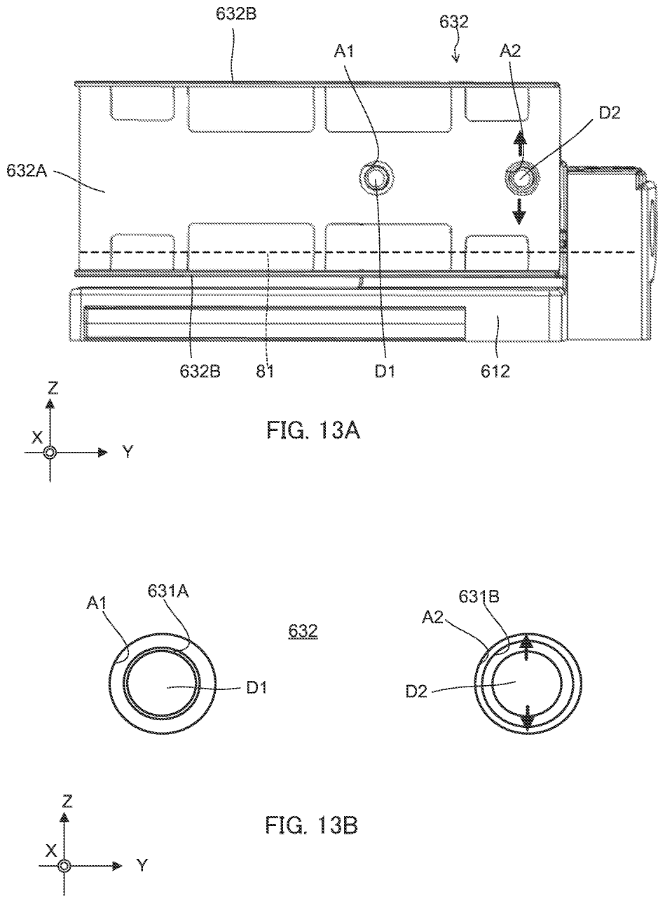

Engaging hole 631B is disposed near the end portion of first interposition member 631 on the + side in the Y direction, and is engaged with protrusion D2. Engaging hole 631B is formed in a size allowing engagement with protrusion D2, and such that the inner edge of engaging hole 631B is spaced from protrusion D2 by a distance allowing movement of the engaging hole with respect to protrusion D2 (see FIG. 13B).

Engaging holes 631A and 631B thus formed make it possible to allow interposition part 63 to rotate around engaging hole 631A (protrusion D1) within the range of engaging hole 631B as illustrated in FIGS. 13A and 13B. As a result, the attitude of interposition part 63 can be adjusted so that contact portions 632B of interposition part 63 are parallel to the guide shaft.

As illustrated in FIG. 11, second interposition member 632 is formed of, for example, a plate-like metal member, and is adhesively fixed to, for example, first interposition member 631. Second interposition member 632 includes main body portion 632A and contact portions 632B.

Main body portion 632A is a portion that has a plane parallel to the direction of the optical axis (Y direction), and is adhesively fixed to first interposition member 631. Holes Al and A2 through which two protrusions D1 and D2 of fourth portion 611D of frame 61 pass are formed in main body portion 632A.

Contact portions 632B are portions with which an oscillator of ultrasonic motor 64 makes contact, and are formed by bending the end portions of main body portion 632A on both sides in the Z-direction toward the side opposite to the lens part. Thus, main body portion 632A connecting together the pair of contact portions 632B is disposed to cover ultrasonic motor 64 from the − side in the X direction, and contact portions 632B are disposed to sandwich ultrasonic motor 64 (resonant portion 641).

Interposition part 63 thus configured generates a thrust in the direction of the optical axis (Y direction) in interposition part 63 by a force acting on contact portions 632B from the oscillator of ultrasonic motor 64. As a result, it is possible to impart a thrust from interposition part 63 to frame 61 for movement in the direction of the optical axis (Y direction).

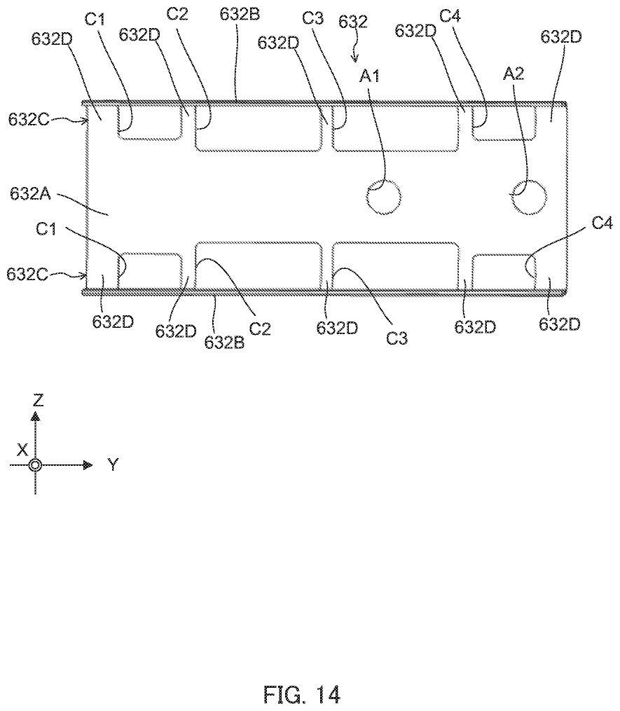

As illustrated in FIG. 14, a plurality of openings C1, C2, C3, and C4 are formed in connecting portions 632C between main body portion 632A and contact portions 632B. The plurality of openings C1, C2, C3, and C4 disposed side by side in the Y direction are four in number on each side of the connecting portions in the Y direction.

Of four openings C1, C2, C3, and C4, two openings C2 and C3 on the central side in the Y direction are configured to have lengths in the Y direction and in the Z direction that are longer than the lengths of two opening C1 and C4 on the both end sides.

Further, four openings C1, C2, C3, and C4 are formed, and thus, in connecting portions 632C, five connecting sections 632D arranged at intervals in the direction of the optical axis are formed.

The widths of connecting sections 632D in the Y direction (direction of the optical axis) increase in the order from the connecting section in the middle in the Y direction toward connecting section 632D located on the outer side in the present embodiment. Specifically, middle connecting section 632D in the Y-direction is the narrowest of five connecting sections 632D. Connecting sections 632D at both ends in the Y-direction are the widest of five connecting sections 632D. Connecting sections 632D located between middle connecting section 632D and connecting sections 632D at both ends are wider than middle connecting section 632D and narrower than connecting sections 632D at both ends.

The closer the connecting sections 632D is located to the end sides, the lower the strengths of connecting sections 632D (connecting portion 632C). Thus, in the present embodiment, the strengths of connecting portions 632C are adjusted by changing the sizes of openings C1, C2, C3, and C4 and the widths of connecting sections 632D in connecting portion 632C.

With the configuration as described above, it is possible to equalize the pressing force applied by oscillator 641B at each position of contact portion 632B in the entire Y-direction. As a result, in the device mounted in a portable terminal such as a smart phone, for example, the moving force by interposition part 63 can be stably generated during operation of the stepless optical zoom function even when the movable part is moved within a relatively long movement range.

As illustrated in FIGS. 10 and 11, wear suppressing portion 632E is disposed on each of the surfaces of two contact portions 632B facing each other.

Wear suppressing portions 632E are a member for suppressing wear caused when oscillators 641B of ultrasonic motor 64 and contact portions 632B are in contact with each other. Wear suppressing portions 632E are made of a material having a hardness higher than the hardness of contact portions 632B (for example, ceramic such as zirconia) and are disposed on contact portions 632B over the Y-direction.

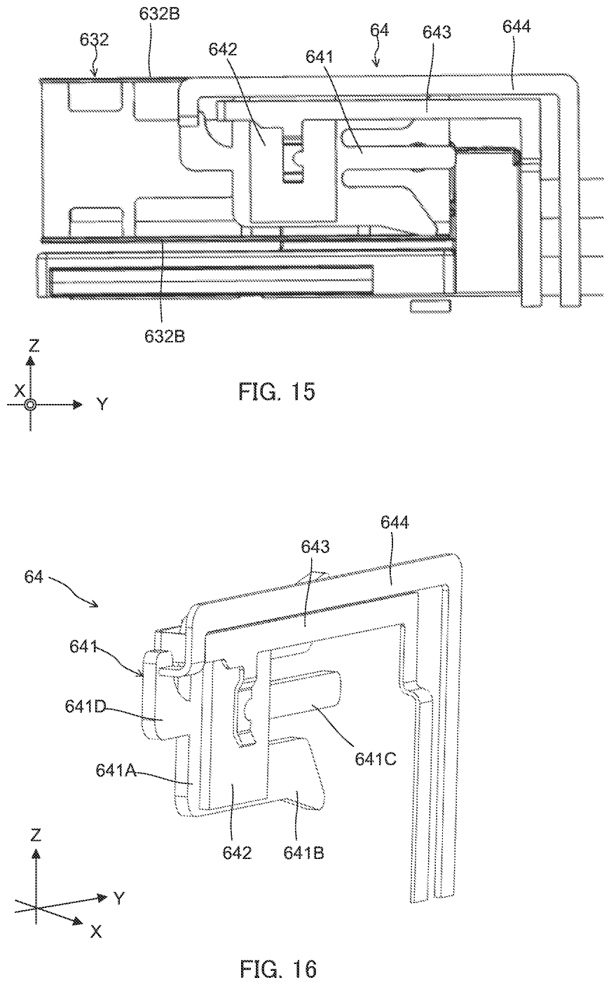

As illustrated in FIGS. 15 and 16, ultrasonic motor 64 is a driving source for generating a driving force for moving frame 61, and is fixedly disposed on each of placement portions 111A of first wall 111 on the + side in the X direction (see FIG. 3 or the like). Ultrasonic motor 64 includes resonant portion 641, piezoelectric elements 642, first electrode 643, and second electrode 644.

One of ultrasonic motors 64 on the − side in the Y direction corresponds to the “first ultrasonic motor” of the present invention, and the other one of ultrasonic motors 64 on the +side in the Y direction corresponds to the “second ultrasonic motor” of the present invention.

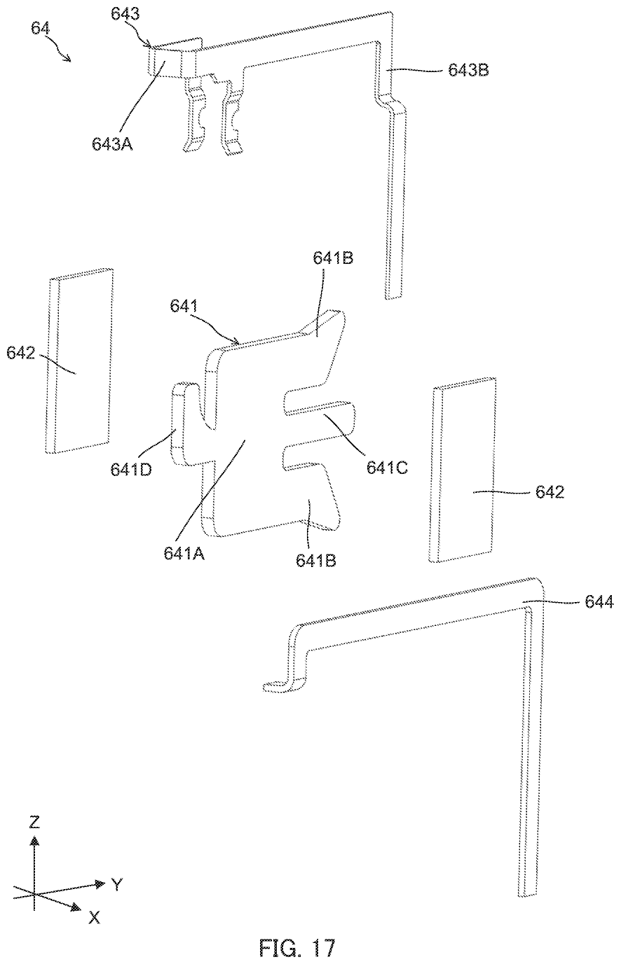

Resonant portion 641 is formed of, for example, a conductive material and resonates with the vibration of piezoelectric elements 642 to convert a vibrational motion into a linear motion of frame 61. Specifically, resonant portion 641 vibrates in an inclination direction inclined with respect to the direction of the optical axis (Y direction) based on the vibration of piezoelectric elements 642 so as to press interposition part 63. Accordingly, a thrust to move frame 61 via interposition part 63 in the direction of the optical axis is generated. Resonant portion 641 is disposed to be sandwiched between two contact portions 632B of interposition part 63. As illustrated in FIG. 17, resonant portion 641 includes body portion 641A, two oscillators 641B, protruding portion 641C, and energization portion 641D.

Body portion 641A is configured in a substantially rectangular shape, for example, and is a portion sandwiched between piezoelectric elements 642. Two oscillators 641B extend in the Y-direction from both ends of body portion 641A in the Z-direction. Two oscillators 641B have symmetrical shapes, and their respective free end portions make contact with contact portions 632B of interposition part 63. Two oscillators 641B correspond to the “first oscillator” and the “second oscillator” of the present invention.

Protruding portion 641C extends to the + side in the Y direction from the central portion of body portion 641A in the Z direction. Energization portion 641D extends to the side opposite to protruding portion 641C (the − side in the Y direction) from the central portion of body portion 641A in the Z direction.

Each of piezoelectric elements 642 is, for example, a vibration element formed of a ceramic material in a plate shape, and generates vibration by application of a high-frequency voltage. Two piezoelectric elements 642 are disposed to sandwich body portion 641A of resonant portion 641 in the X-direction, respectively.

First electrode 643 includes clamping portion 643A for clamping resonant portion 641 and piezoelectric elements 642, and electrode portion 643B to which a voltage is applied. Via clamping portion 643A for clamping piezoelectric elements 642 and the like, first electrode 643 applies a voltage to piezoelectric elements 642. Second electrode 644 is electrically connected to energization portion 641D of resonant portion 641. First electrode 643 and second electrode 644 make contact with the terminal of terminal portion 111C described above inside housing 10.

Two piezoelectric elements 642 are bonded to body portion 641A of resonant portion 641 and are held in between by first electrode 643, so that these are electrically connected to one another. For example, one side of a power supply path is connected to first electrode 643, and the other side is connected to second electrode 644. A voltage is applied to piezoelectric elements 642, and a vibration is thus generated.

Resonant portion 641 has at least two resonant frequencies, and deforms in behaviors different between the resonant frequencies. In other words, the entire shape of resonant portion 641 is set such that resonant portion 641 deforms in behaviors different between the two resonant frequencies. The different behaviors mean behaviors of moving frame 61 to the + side and to the − side in the Y direction via interposition part 63.

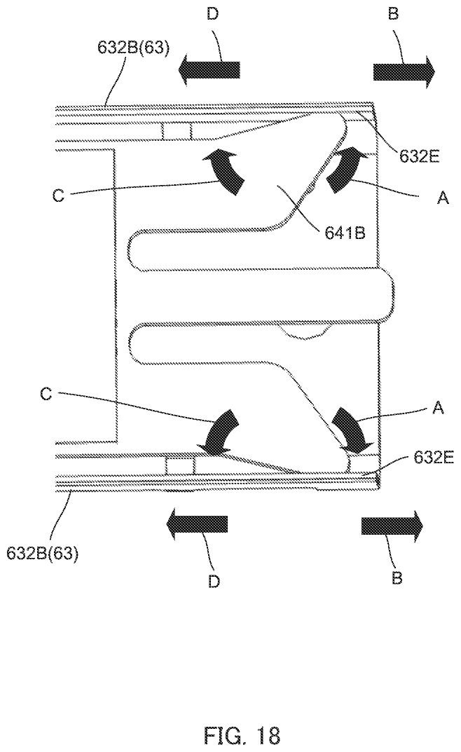

As illustrated in FIG. 18, resonant portion 641 is disposed such that either of the pair of contact portions 632B of interposition part 63 and oscillators 641B face each other. Thus, when two oscillators 641B are deformed, the tip ends of oscillators 641B press (see arrows A) contact portions 632B in a direction inclined with respect to the Y direction from the opposing sides of contact portions 632B.

When contact portions 632B are pressed in the directions of arrows A by the tip ends of oscillators 641B, reaction forces of the contact portions returning on the oscillators 641B sides are generated at contact portions 632B. In other words, interposition part 63 generates a reaction force in a direction from the outside of the pair of contact portions 632B toward the inside based on the contact between oscillators 641B and the pair of contact portions 632B.

By the reaction force of interposition part 63 with respect to the press of oscillators 641B, the friction generated between oscillators 641B and contact portions 632B causes a thrust in the Y direction in interposition part 63. Accordingly, the thrust for movement in the Y direction is applied to frame 61 to be bonded to interposition part 63 (see arrow B). As a result, second lens unit 32 or third lens unit 33 connected to frame 61 is moved in the Y direction.

Further, contact portions 632B are configured to extend in the Y direction. When pressed against oscillators 641B, contact portions 632B move in the Y direction while making sliding contact with oscillators 641B. Therefore, contact portions 632B are continuously pressed by oscillators 641B. Thus, frame 61 to be bonded to interposition part 63 can be moved continuously in the Y-direction. Note that, at a certain resonant frequency, the pressing directions of oscillators 641B are the directions of arrows A and the sliding direction of contact portions 632B is the direction of arrows B, whereas at another resonance frequency, the pressing directions of oscillators 641B are the directions of arrows C and the sliding direction of contact portions 632B is the direction of arrows D.

Such driving operation is performed by each of ultrasonic motors 64 disposed on each of first walls 111 on both sides in the X direction. That is, ultrasonic motors 64 respectively drive second lens unit 32 and third lens unit 33 independently in the direction of the optical axis.

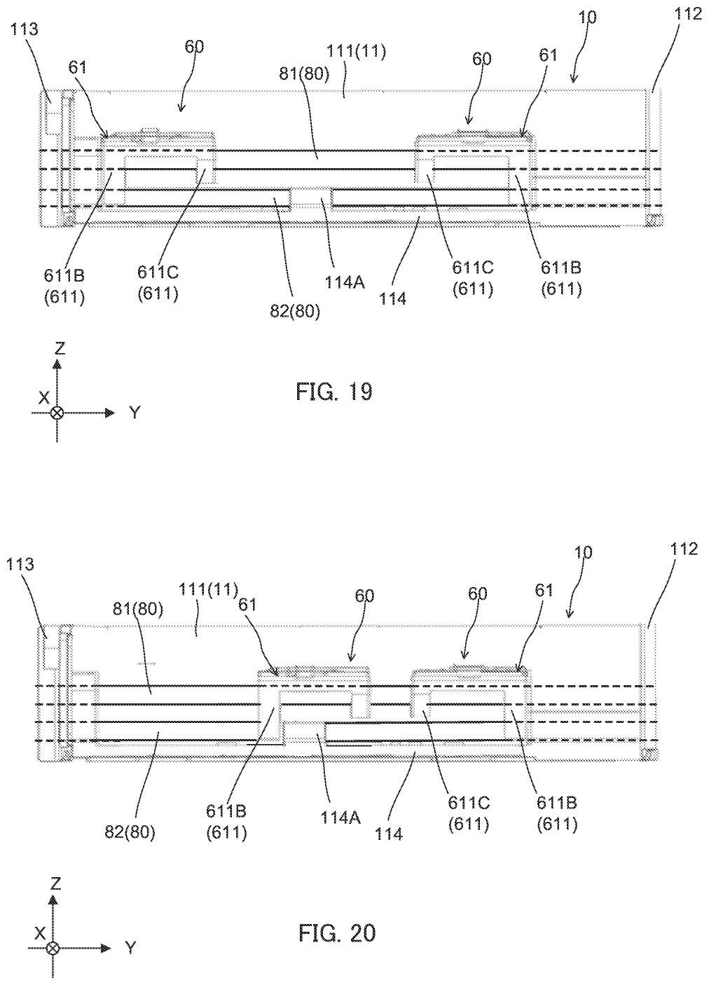

As illustrated in FIG. 19, their movements are guided by guide part 80. Guide part 80 is disposed in the region of one of fourth walls 114 on the + side in the X direction that is surrounded by first wall 111, second wall 112, and third wall 113. That is, guide part 80 is disposed in housing 10 on one end side of opposite ends of second lens unit 32 and third lens unit 33 with respect to optical axis O (see also FIG.7).

Guide part 80 includes first guide shaft 81 and second guide shaft 82, both of which extend in the direction of the optical axis (Y direction). The first and the second guide shafts are disposed to be spaced apart from each other and cooperate to support both of two frames 61 such that the frames are movable in the direction of the optical axis. First guide shaft 81 and second guide shaft 82 are formed from, for example, stainless steel or the like, and are supported by guide supporting portions (not illustrated) of second wall 112 and third wall 113 of housing 10 at both ends in the optical axis (both ends in the X direction). Second wall 112 and third wall 113 correspond to a “pair of walls” extending from the bottom wall (fourth wall 114) of the present invention.

First guide shaft 81 is a guide shaft for guiding the movement of each of frames 61 by supporting second portion 611B and third portion 611C of guided portion 611 of frame 61.

Second guide shaft 82 is a guide shaft disposed parallel to first guide shaft 81 on the − side (fourth wall 114 side) of first guide shaft 81 in the Z direction, and for guiding the movement of frame 61 by supporting (being engaged with) second portion 611B of guided portion 611 of frame 61. In addition, first guide shaft 81 and second guide shaft 82 are disposed at substantially the same position in the X direction as one of above-described support shafts 50, as illustrated in FIG. 10.

Second guide shaft 82 is supported by bearing portion 114A disposed on fourth wall 114. Bearing portion 114A is disposed between two frames 61 to protrude from fourth wall 114 to the + side in the Z direction, and is disposed in the vicinity of the central portion of second guide shaft 82 in the Y direction. Second guide shaft 82 is adhesively fixed to bearing portion 114A. Further, bearing portion 114A is disposed in a range including center 82A of second guide shaft 82 in the X direction (direction between opposite ends with respect to the optical axis) (see FIG. 10).

Further, bearing portion 114A is disposed at a position where contact with second portion 611B of frame 61 is possible. Therefore, when frame 61 is moved to the + side in the Y direction, second portion 611B and bearing portion 114A of frame 61 make contact with each other (see FIG. 20). Thus, bearing portion 114A restricts the movement of frame 61. Bearing portion 114A corresponds to the “restricting portion” of the present invention.

According to the present embodiment configured as described above, the two guide shafts disposed for guiding the movement of two lens driving parts 60 include first guide shaft 81 and second guide shaft 82. It is thus possible to improve the strength of housing 10.

Specifically, for example, when an external force is applied to housing 10, the stress applied to the guide shafts is distributed to two guide shafts, first guide shaft 81 and second guide shaft 82. As a result, the force applied to housing 10 can be reduced as a whole. Accordingly, the strength of housing 10 can be improved.

Further, in the present embodiment, ultrasonic motor 64 formed by bonding thin plate-shaped members such as resonant portion 641, piezoelectric elements 642, and the like is used in lens driving part 60. It is thus possible to reduce the arrangement space for the driving source. As a result, it is possible to reduce the size of camera module 1 (lens driving device) as compared with a configuration using a stepping motor or the like as a driving source.

In other words, in the present embodiment, it is possible to achieve miniaturization of the device while securing the rigidity of the device.

Further, by disposing first guide shaft 81 and second guide shaft 82, it is possible to restrict the rotation of frames 61 around the shafts.

In addition, first guide shaft 81 and second guide shaft 82 are supported by second wall 112 and third wall 113 of housing 10. Thus, the strength of housing 10 entirely in the Y direction can be further improved.

Further, bearing portion 114A restricts the movement of frames 61. It is thus possible to prevent excessive movement of frames 61. As a result, it is possible to reduce the collision between two frames 61. Further, it is possible to mitigate the impact force caused when two frames 61 collide with each other.

Further, bearing portion 114A makes contact with second portion 611B of guided portion 611 of frame 61. Second portion 611B is disposed on the end portion of guided portion 611 on the side farther than bearing portion 114A. Thus, it is possible to increase the stroke amount of frame 61 accordingly, as compared with the configuration in which second portion 611B is disposed on the end portion on the side closer to the bearing portion.

Further, bearing portion 114A is disposed in a range including center 82A of second guide shaft 82 in the X direction. Thus, a portion of second guide shaft 82 on the − side in the Z direction is supported stably by bearing portion 114A. Therefore, it is possible to prevent second guide shaft 82 from being deflected in the Z direction even when an external force is applied to housing 10, such as when housing 10 is dropped. It is thus possible to improve the strength of housing 10.

Further, by adhesively fixing bearing portion 114A to second guide shaft 82, it is possible to suppress bent of second guide shaft 82 in the X-direction.

In addition, absorbing part 613 is disposed between fourth portion 611D and second guide shaft 82. Thus, absorbing part 613 can press second guide shaft 82 against the wall portion forming shaft engaging portion 611F. As a result, it is possible to absorb a deviation of the positional relationship between frame 61 and absorbing part 613 caused due to manufacturing tolerances or the like. It is thus possible to maintain a stable attitude during movement of frame 61. Accordingly, it is possible to suppress variations in the movement resistance.

Further, second guide shaft 82 and third portion 611C of frame 61 are disposed with a gap in between. When first guide shaft 81 is bent in the Z direction, third portion 611C and second guide shaft 82 make contact with each other. For example, even when first guide shaft 81 is plastically deformed, it is possible to support first guide shaft 81 from the − side in the Z direction by second guide shaft 82 by reducing the gap as much as possible. It is thus possible to reduce the amount of deformation of first guide shaft 81.

In addition, wear suppressing portions 632E are disposed on contact portions 632B of interposition part 63. Each of wear suppressing portion 632E is made of a material having a hardness higher than that of interposition part 63. It is thus possible to suppress wear caused by contact with oscillator 641B, as compared with a configuration in which the contact portion makes direct contact with oscillator 641B. In addition, contact portion 632B can be reinforced by disposing wear suppressing portion 632E. It is thus possible to suppress the bent of contact portion 632B.

Further, first guide shaft 81 and second guide shaft 82 are disposed at substantially the same position as one of support shafts 50 in the X direction. It is thus possible to keep the arrangement range of these shafts within a certain range in the X direction. As a result, it is possible to reduce the width in the X direction, so as to reduce the size of the device.

Note that, in the above embodiment, a configuration having two guide shafts is employed, but the present invention is not limited thereto. The present invention may have a configuration having, for example, three or more guide shafts.

In the above embodiment, position detecting part 70 is disposed for each frame 61. However, the present invention is not limited thereto. For example, a plurality of position detecting parts may be arranged side by side in the direction of the optical axis (Y direction).

With such a configuration, it is possible to further improve the accuracy of the position detection for frame 61.

In the above embodiment, support shafts 50 are disposed on both sides in the X direction, but the present invention is not limited to this, and support shaft 50 may be disposed on only one side in the X direction.

In the above embodiment, side wall portion 11 and bottom wall portion 12 of housing 10 are formed by insert molding. However, the present invention is not limited to this, and the bottom wall portion may be adhesively fixed to side wall portion 11.

Further, the above embodiment employs the configuration having two movable lenses composed of second lens unit 32 and third lens unit 33, but the present invention is not limited to this, and the configuration may have three or more movable lenses.

Further, the above embodiment employs the configuration having four lens units, but the present invention is not limited to this, and any number of lens units may be provided as long as the configuration has at least two movable lenses.

In the above embodiment, interposition part 63 is formed by bending a plate-like metal member, but the present invention is not limited to this, and the main body portion and the contact portion forming the interposition part may be formed by separate members.

In the above embodiment, frame 61 and interposition part 63 are formed of separate members, but the present invention is not limited thereto. For example, frame 61 and interposition part 63 may be integrally formed. That is, the lens driving part may include a moving portion that moves in the direction of the optical axis in accordance with resonance of the resonant portion and is connected to each of the lens units so as to transmit the movement in the direction of the optical axis.

In the above embodiment, each of connecting parts 62 connecting together frame 61 and the lens unit includes the spring member, but the present invention is not limited to this, and any member may be included as long as it is a member having elasticity.

Although the position of frame 61 is detected using magnet part 614 in the above embodiment, the present invention is not limited to this, and the position of the frame may be detected by another method.

Further, in the above embodiment, third portion 611C of frame 61 is disposed to be spaced apart from second guide shaft 82, but the present invention is not limited to this, and a configuration may also be used in which the third portion may also support the second guide shaft.

Further, in the above embodiment, nothing is disposed at an opposing portion of third portion 611C facing second guide shaft 82, but the present invention is not limited to this, and a shock absorbing member or the like may be disposed on this opposing portion.

The above embodiment has the configuration in which the bottom wall portion includes the bent portions or half punches, but the present invention is not limited to this, and a configuration may also be used in which the bottom wall portion does not includes any bent portion or half punch.

In the above embodiment, resonant portion 641 includes two oscillators 641B, but the present invention is not limited to this, and the present invention may have a configuration in which the resonant portion includes one oscillator, for example.

In the above embodiment, the drive control part, the reflection drive control part, and the image capturing control part are disposed separately, but the present invention is not limited to this, and at least two of the drive control part, the reflection drive control part, and the image capturing control part may be composed of one control part.

Further, in the above embodiment, bearing portion 114A is provided as the restricting portion, but the present invention is not limited to this, and the restricting portion may also be provided separately from the bearing portion or the bearing portion does not have to have a portion having the function of the restricting portion.

Further, although bearing portion 114A is provided in the above embodiment, the present invention is not limited to this, and the present invention does not have to be provided with any bearing portion.

In addition, in the above embodiment, absorbing part 613 is provided, but the present invention is not limited thereto, and no absorbing part may be provided.

For example, while a smartphone serving as a camera-equipped mobile terminal has been described in the above embodiment as an example of the camera-mounted device including camera module 1, the present invention is applicable to a camera-mounted device including a camera module and an image processing part that processes image information obtained by the camera module. The camera-mounted device encompasses an information apparatus and a transporting apparatus. Examples of the information apparatus include a camera-mounted mobile phone, a note-type personal computer, a tablet terminal, a mobile game machine, a web camera, drone, and a camera-mounted in-vehicle device (for example, a rear-view monitor device or a drive recorder device). In addition, examples of the transporting apparatus include an automobile, drone, and/or the like.

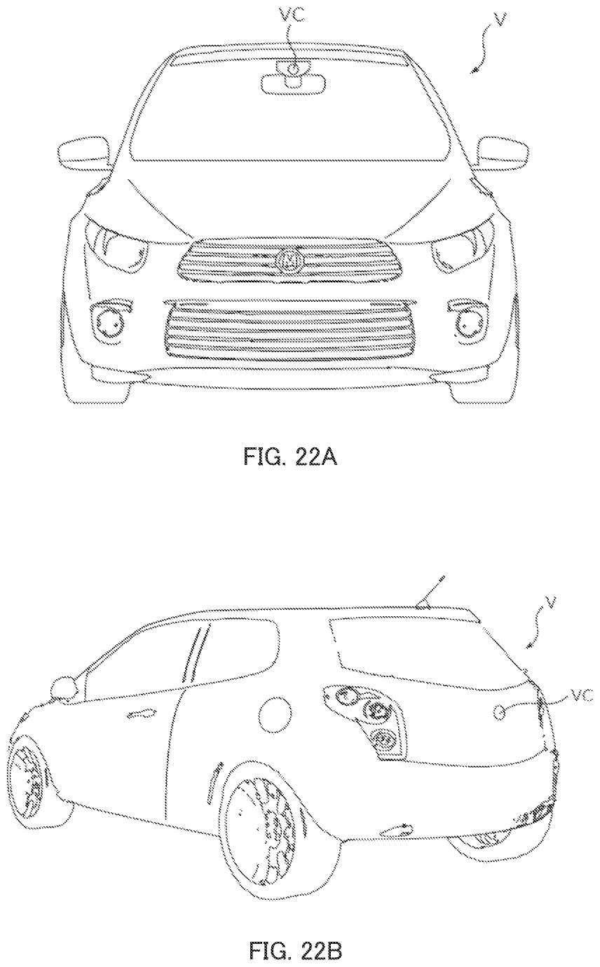

FIGS. 22A and 22B illustrate automobile V serving as the camera-mounted device in which in-vehicle camera module VC (Vehicle Camera) is mounted. FIG. 22A is a front view of automobile V and FIG. 22B is a rear perspective view of automobile V. In automobile V, camera module 1 described in the embodiment is mounted as in-vehicle camera module VC. As illustrated in FIGS. 22A and 22B, in-vehicle camera module VC may, for example, be attached to the windshield so as to face forward, or to the rear gate so as to face backward. In-vehicle camera module VC is used for rear monitoring, drive recording, collision avoidance control, automatic drive control, and the like.

In addition, the aforementioned embodiments merely describe examples of implementations for practicing the present invention, and should not be construed as limiting the technical scope of the present invention. That is, the present invention can be embodied in various forms without departing from the spirit, scope, or principal features of the present invention. For example, the shape, size, number, and material of each part described in the above embodiment are merely examples, and can be changed as appropriate.

The disclosure of U.S. Patent Application No. 62/960727, filed on Jan. 14, 2020, including the specification, drawings and abstract is incorporated herein by reference in its entirety.

### INDUSTRIAL APPLICABILITY

The lens driving device according to the present invention is useful as a lens driving device, a camera module, and a camera-mounted device capable of achieving miniaturization of the device while securing the rigidity of the device.

### REFERENCE SIGNS LIST

1 Camera Module
10 Housing
11 Side wall portion
12 Bottom wall portion
20 Reflection driving part
21 Reflecting housing
22 Mirror
23 Reflection drive control part
30 Lens part
31 First lens unit
32 Second lens unit
32A Main body portion
32B Supported portion
33 Third lens unit
33A Main body portion
33B Supported portion
34 Fourth lens unit
34A Protruding portion
40 Image capturing part
50 Support shaft
60 Lens driving part
61 Frame
62 Connecting part
63 Interposition part
64 Ultrasonic motor
70 Position detecting part
80 Guide part
81 First guide shaft
82 Second guide shaft
100 Drive control part
111 First wall
111A Placement portion
111B Engaged portion
111C Terminal portion
112 Second wall
112A Supporting portion
112B Placement portion
112C Guide supporting portion
112D Opening portion
113 Third wall
113A Bridging portion
113B Supporting portion
113C Guide supporting portion
114 Fourth wall
114A Bearing portion
121 Positioning portion
122 Bent portion
123 Half punch
200 Image capturing control part
611 Guided portion
611A First portion
611B Second portion
611C Third portion
611D Fourth portion
612 Magnet holding portion
613 Absorbing part
614 Magnet part
614A Magnet
614B Magnet
614C Opposing surface
614D boundaries
631 First interposition member
631A Engaging hole
631B Engaging hole
632 Second interposition member
632A Main body portion
632B Contact portion
632C Connecting portion
632D Connecting section
632E Wear suppressing portion
641 Resonant portion
641A Body portion
641B Oscillator
641C Protruding portion
641D Energization portion
642 Piezoelectric element
643 First electrode
643A Clamping portion
643B Electrode part
644 Second electrode

1. A lens driving device, comprising:
a first movable part and a second movable part that are disposed in a direction of an optical axis and are capable of holding a first movable lens and a second movable lens, respectively;
a first driving part and a second driving part, both of which are disposed on one end side of opposite ends of the first movable part and the second movable part with respect to the optical axis, the first driving part and the second driving part being configured to drive the first movable part and the second movable part in the direction of the optical axis, respectively; and
a guide part that is disposed on the one end side and is configured to guide movement of each of the first movable part and the second movable part in the direction of the optical axis, wherein
the first driving part includes a first ultrasonic motor and a first frame connected to the first movable part,
the second driving part includes a second ultrasonic motor and a second frame connected to the second movable part,
the first ultrasonic motor and the second ultrasonic motor are disposed side by side in the direction of the optical axis on the one end side, and are configured to respectively drive the first movable part and the second movable part independently in the direction of the optical axis, and
the guide part includes a plurality of guide shafts that extend in the direction of the optical axis and are disposed to be spaced apart from each other, the plurality of guide shafts being configured to cooperate to support both of the first frame and the second frame such that the first frame and the second frame are movable in the direction of the optical axis.

2. The lens driving device according to claim 1, further comprising:
a restricting portion that is disposed between the first frame and the second frame in the direction of the optical axis, and is configured to restrict movement of the first frame and movement of the second frame.

3. The lens driving device according to claim 1, further comprising:
a housing that houses at least the first movable part, the second movable part, the first driving part, and the second driving part, wherein
the housing includes a bottom wall and a pair of walls, the pair of walls being disposed on both end sides of the optical axis and extending from the bottom wall, and
the plurality of guide shafts include a first guide shaft and a second guide shaft supported by the pair of walls.

4. The lens driving device according to claim 3, wherein
the second guide shaft is disposed on the bottom wall side of the first guide shaft, and
the bottom wall is provided with a bearing portion for the second guide shaft, the bearing portion being disposed in a range including a center of the second guide shaft between the opposite ends.

5. The lens driving device according to claim 1, further comprising:
an absorbing part for absorbing a deviation in a positional relationship between at least one of the first frame and the second frame and the guide part.

6. The lens driving device according to claim 1, wherein
the plurality of guide shafts include two guide shafts arranged in a predetermined direction, and
at least one of the first frame and the second frame includes:
a first portion extending in the direction of the optical axis,
a second portion that extends in the predetermined direction from one end of the first portion and through which the two guide shafts pass, and
a third portion that extends in the predetermined direction from another end of the first portion and through which one of the two guide shafts passes, the third portion being disposed to be spaced apart from another of the two guide shafts.

7. The lens driving device according to claim 1, wherein
each of the first ultrasonic motor and the second ultrasonic motor includes a resonant portion including a first oscillator and a second oscillator that resonate,
the first driving part and the second driving part include an interposition part interposed between the first ultrasonic motor and the first frame and an interposition part interposed between the second ultrasonic motor and the second frame, respectively,
the interposition part includes:
a pair of contact portions that are disposed to sandwich the resonant portion and make contact with the first oscillator and the second oscillator, respectively, and
a main body portion connecting between the pair of contact portions, and
each of the contact portions includes a wear suppressing portion for suppressing wear caused by contact with one of the first oscillator and the second oscillator.

8. The lens driving device according to claim 7, wherein
the wear suppressing portion is formed of a material having a higher hardness than the contact portions.

9. The lens driving device according to claim 8, wherein
the wear suppressing portion is formed of ceramic.

10. The lens driving device according to claim 7, wherein
the wear suppressing portion is a portion of the contact portions on which hardening processing is performed.

11. A camera module, comprising:
the lens driving device according to claim 1;
a lens part including the first movable lens and the second movable lens held by the first movable part and the second movable part; and
an image capturing part configured to capture a subject image imaged by the lens part, wherein
the first movable lens and the second movable lens are driven in the direction of the optical axis.

12. A camera-mounted device that is an information apparatus or a transporting apparatus, the camera-mounted device comprising:
the camera module according to claim 11; and
an image capturing control part that processes image information obtained by the camera module.
